(19) United States
(12) Patent Application Publication
(10) Pub. No.: US 2002/0034225 A1
(43) Pub. Date: Mar. 21, 2002

(54) Coding of a data stream

(76) Inventors: Maria Giuseppina Martini, Perugia (IT); Marco Chiani, Rimini (IT)

Correspondence Address: U.S. Philips Corporation, 580 White Plains Road, Tarrytown, NY, 10591, US

(21) Appl. No.: 09/906,595

(22) Filed: Jul. 17, 2001

(30) Foreign Application Priority Data
Jul. 17, 2000 (EP) 00202530.2

(51) Int. Cl. H04N 7/12

(52) U.S. Cl. 375/240.01; 375/240.27

(57) ABSTRACT

Coding of a data stream is provided, the data stream comprising at least one marker out of a predetermined set of at least two mutually different markers, the marker indicating a start of a given part of the data stream, wherein the at least one marker is represented with a higher-robustness word having a higher robustness to channel errors than the at least one marker, e.g. a pseudo-noise word. Advantageously, the higher-robustness word representing the at least one marker is obtained from a predetermined set of higher-robustness words, each higher-robustness word in the predetermined set of higher-robustness words corresponding to a given marker in the predetermined set of markers.

Further, decoding is provided, wherein a position of a given higher-robustness word is determined by correlating the received data stream with higher-robustness words obtained from a predetermined set of higher-robustness words and the given higher-robustness word is decoded to obtain a marker represented by the higher-robustness word at the determined position.

The invention relates to coding and decoding of a data stream.

The invention further relates to transmission and reception of a data stream.

Reference is made to the article of M. Budagavi, W. Rabiner Heinzelman, J. Webb, R. Talluri, “Wireless MPEG-4 Video Communication on DSP Chips”, IEEE Signal Processing Magazine, January 2000. This article discloses that, to make the compressed bit-stream more robust, the MPEG-4 video compression standard incorporates several error resilience tools in its simple profile to enable detection, containment, and concealment of errors. These are powerful source-coding techniques for combating bit errors when they occur at rates less than 10⁻³; however, present-day wireless channels can have much higher bit error rates (BERs). The harsh conditions on mobile wireless channels result from multipath fading due to motion between the transmitter and the receiver, and changes in the surrounding terrain. Multipath fading manifests itself in the form of long bursts of errors. Hence, some form of interleaving and channel coding is required to improve the channel conditions. Using a combination of source and channel coding, it is possible to achieve acceptable visual quality over error-prone wireless channels with MPEG-4 simple-profile video compression. The structure of an MPEG-4 compressed bit-stream also lends itself to using unequal error protection, a form of joint source-channel coding, to ensure fewer errors in the important portions of the bitstream.

An object of the invention is to provide an improved transmission of data. To this end, the invention provides coding, decoding, transmission, reception, a data stream and a storage medium as defined in the independent claims. Advantageous embodiments are defined in the dependent claims.

The invention is especially advantageous in the field of wireless transmission of MPEG-4 video. The inventors recognized that MPEG-4 start codes are not robust to channel errors, resulting in a loss of synchronization in the case of channel errors. The invention provides more robust start codes, resulting in a better synchronization of the received data stream.

According to a first aspect of the invention, the data stream comprises at least one marker out of a predetermined set of at least two mutually different markers, the marker indicating a start of a given part of the data stream, wherein the at least one marker is represented with a higher-robustness word having a higher robustness to channel errors than the at least one marker. The higher-robustness word may be a higher-robustness word with higher correlation properties than the respective marker, and is preferably a pseudo-noise word. Using higher-robustness words with higher correlation properties to represent markers makes transmission of these markers more robust against transmission errors.

John G. Proakis, ‘Digital communications’, 2^{nd} edition, McGraw-Hill, 1989, pp. 801-817 discloses spread-spectrum signals for digital communications. Spread-spectrum signals used for the transmission of digital information are distinguished by the characteristic that their bandwidth W is much greater than the information rate R in bits per second. That is, the bandwidth expansion factor Bₑ=W/R for a spread-spectrum signal is much greater than unity. The large redundancy inherent in spread-spectrum signals is required to overcome the severe levels of interference that are encountered in the transmission of digital information over some radio and satellite channels. Proakis discloses a spread-spectrum digital communications system with a binary information sequence at its input at the transmitting end and at its output at the receiving end. The channel encoder and decoder and the modulator and demodulator are basic elements. In addition to these elements, two identical pseudo-random pattern generators, one which interfaces with the modulator at the transmitting end and the second which interfaces with the demodulator at the receiving end. The generators generate a pseudo-random or pseudo-noise (PN) binary-valued sequence, which is impressed on the transmitted signal at the modulator and removed from the received signal at the demodulator. Synchronization of the PN sequence generated at the receiver with the PN sequence contained in the incoming received signal is required in order to demodulate the received signal. Initially, prior to the transmission of information, synchronization may be achieved by transmitting a fixed pseudo-random bit pattern, which the receiver will recognize in the presence of interference with a high probability. After time synchronization of the generator is established, the transmission of information may commence. Generation of PN sequences is further explained on pages 831-836.

According to an embodiment of the present invention, by representing markers out of a predetermined set of markers, a limited set of higher-robustness words is needed corresponding to the predetermined set of markers. The invention therefore provides an advantageous detection at a receiver because the receiver only has to check if higher-robustness words out of a limited set occur in the data stream with sufficient probability, wherein the limited set of higher-robustness words corresponds to the predetermined set of markers. In a receiver according an embodiment of to the invention, a given higher-robustness word is preferably detected by correlating the received data stream with higher-robustness words obtained from a predetermined set of higher-robustness words. If the correlation of the received data stream with a given higher-robustness word out of the predetermined set yields a value above a given threshold, the given higher-robustness word is decoded to obtain a corresponding marker at the position of the higher-robustness word. The higher-robustness word is preferably substituted by the corresponding ‘original’ marker. This has the advantage that ‘original’/unaffected markers are present in the MPEG-4 data stream at the receiver after channel decoding. This embodiment of the invention therefore provides advantageous error protection by transparent substitution of start codes with higher-robustness words.

Preferably, the data packets in the data stream are coded according to a channel coding mechanism different from spread-spectrum coding. Advantageously, such a channel coding mechanism comprises proportional unequal error protection or length field insertion, both alternatives being described below.

Advantageously, at the transmitter side, respective markers are substituted with respective higher-robustness words obtained from a predetermined set of higher-robustness words, each higher-robustness word in the set of higher-robustness words representing a given marker in the predetermined set of markers. By substituting the markers by a corresponding higher-robustness word, fast and advantageous coding is provided. The higher-robustness words can fast and easily be obtained from a look-up table. Coding errors that could be obtained when the markers are coded with a pseudo-noise sequence impressed on the marker are avoided.

Although substitution of the markers with respective new higher-robustness words obtained from a predetermined set of higher-robustness words is advantageous, the higher-robustness words with higher correlation properties may alternatively be obtained by impressing a fixed pseudo-noise sequence on the markers at a modulator. In this embodiment, it is possible in the decoder to obtain the original markers by removing the fixed pseudo-random sequence from the higher-robustness words at a demodulator.

The aforementioned and other aspects of the invention will be apparent from and elucidated with reference to the embodiments described hereinafter.

In the drawings:

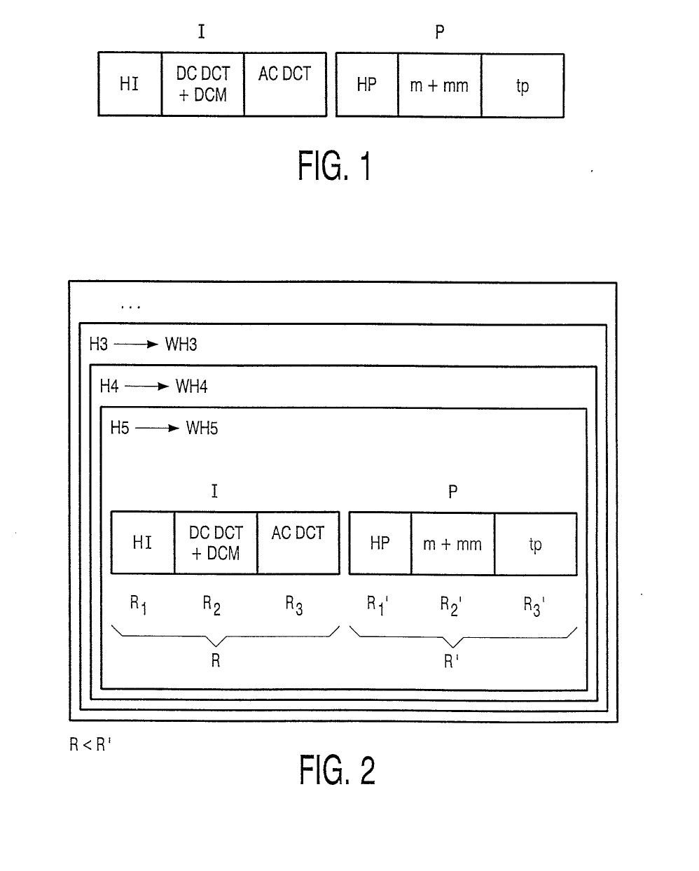

FIG. 1 shows data partitioning in the MPEG-4 bit-stream;

FIG. 2 shows a schematic representation of a protection scheme according to an embodiment of the invention;

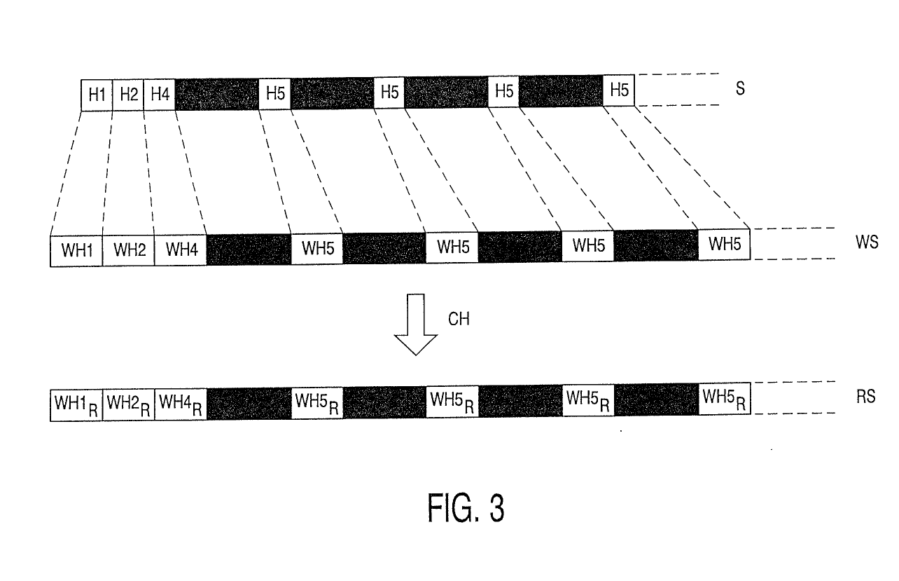

FIG. 3 shows start code substitution according to an embodiment of the invention;

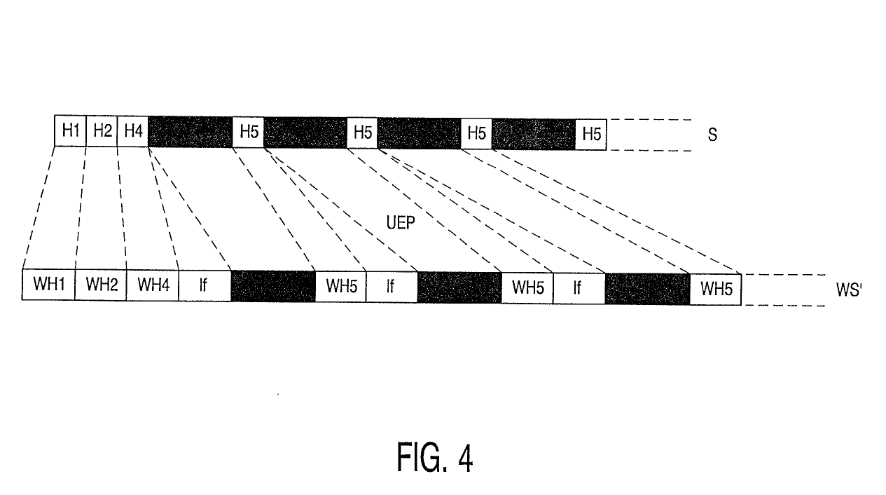

FIG. 4 shows start code substitution, unequal error protection and length field insertion according to an embodiment of the invention;

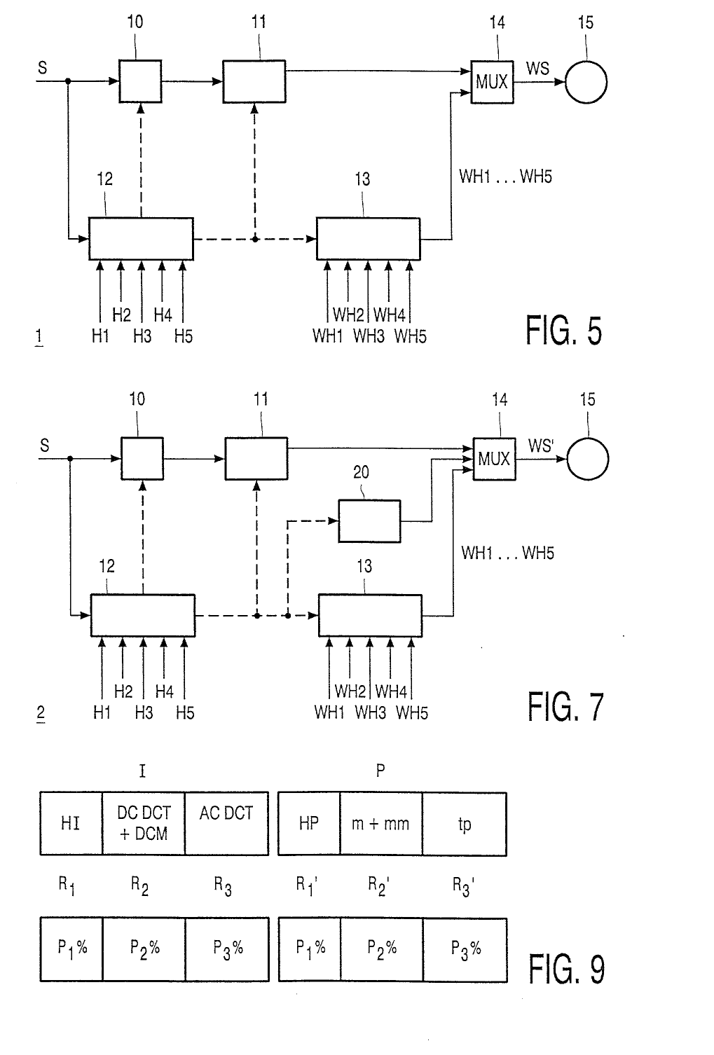

FIG. 5 shows a transmitter according to an embodiment of the invention, the transmitter comprising means for start code detection and substitution;

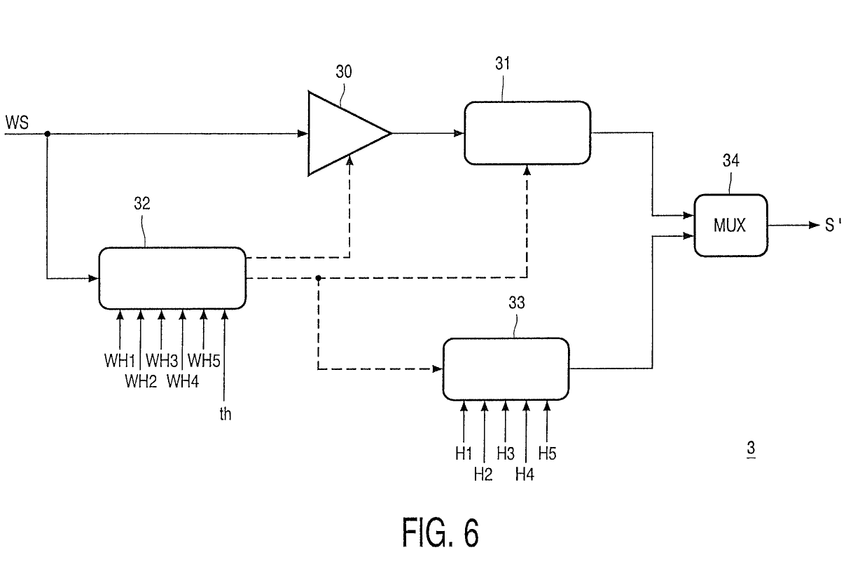

FIG. 6 shows a receiver according to an embodiment of the invention, the receiver comprising means for substituted start code detection and replacement;

FIG. 7 shows a transmitter according to an embodiment of the invention, the transmitter comprising means for start code detection and substitution, and means for length field reading;

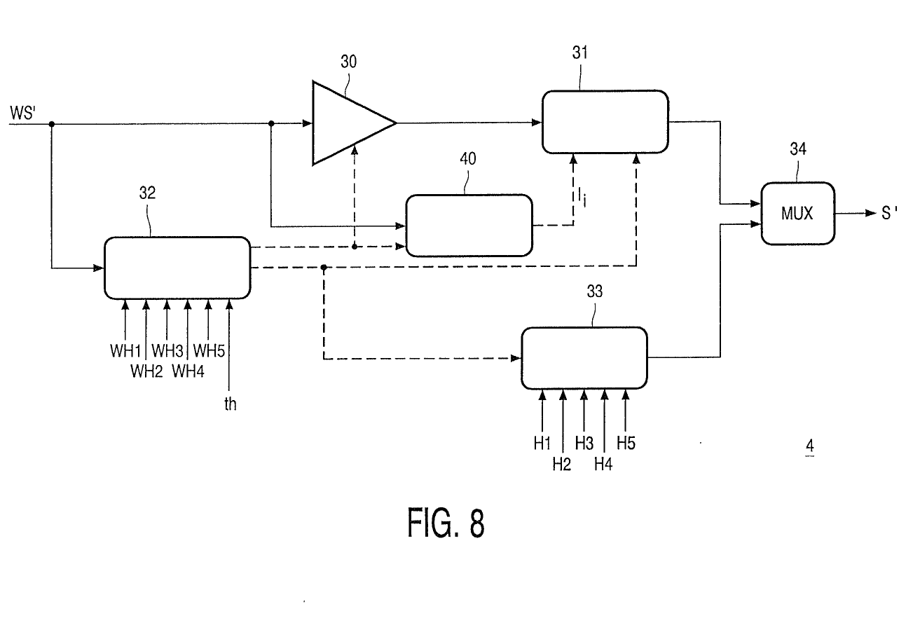

FIG. 8 shows a receiver according to an embodiment of the invention, the receiver comprising means for substituted start code detection and replacement, and means for length field reading; and

FIG. 9 shows proportional unequal error protection according to an embodiment of the invention.

The drawings only show those elements that are necessary to understand the invention.

Due to compression and in particular to the use of predictive coding and Variable Length Coding (VLC), an MPEG-4 bit-stream is very sensitive to errors. The article of R. Talluri, “Error-resilient video coding in the ISO MPEG-4 standard”, IEEE Communication Magazine, vol. 36, no.6, June 1988 describes error resilience aspects of the video coding techniques that are standardized in the ISO MPEG-4 standard. The specific tools adopted into the ISO MPEG-4 standard to enable the communication of compressed video data over noisy wireless channels are presented in detail. These techniques include resynchronization strategies, data partitioning, reversible Variable Length Codes, and header extension codes.

These tools help adding robustness to the MPEG-4 bit-stream. With the use of Resync markers, the MPEG-4 bit-stream results composed of packets, which are of almost the same length. Regardless of such tools, achievable received quality is still poor when MPEG-4 is transmitted over a wireless channel. Error resilience tools can, however, produce a further improvement of the received video quality if exploited at channel coding level. In particular, the data partitioning tool can be usefully exploited with the purpose of performing Unequal Error Protection (UEP): information bits contained in each packet are separated in three partitions, each of which has a different sensitivity to channel errors. As shown in FIG. 1 for I frames, partitions consist of a header HI, and DC DCT coefficients and AC coefficients separated by a DC marker DCm. As far as P frames are concerned, partitions consist of a header HP, and a motion partition m and a texture partition tp separated by a motion marker mm.

A suitable technique taking into account the characteristics of both the wireless channel and of the application is described. Specifically, information about the different sensitivity of source bits to channel errors should be exploited through UEP. This technique consists in performing error protection according to the perceived sensitivity of source bits to errors: more sensitive bits are protected with a higher protection (corresponding to a lower rate code), for less important bits a lower protection (i.e. a higher rate code) is used. Compared to classical Forward Error Correction (FEC), UEP allows achieving a higher perceived video quality given the same bit-rate, through the exploitation of the characteristics of the source.

In the proposed scheme, the three partitions are protected with different code rates, according to the subjective importance of the relevant information. Information contained in headers is crucial for the successive decoding of the packet, thus those should be strongly protected. For intra frames, DC coefficients have a higher subjective importance than AC coefficients; thus the DC coefficients should be higher protected than the AC coefficients. As far as predicted frames are concerned, motion data should be more protected than texture data, as if motion information is correctly received texture information may be partially reconstructed.

The UEP implementation proposed takes also into account the different importance of different types of frames: in the MPEG-4 standard. Intra, Predicted and Backward predicted frames are considered, where Intra frames are coded independently from the others and Predicted frames exploit information from contiguous frames.

A correct reception of Intra frames is crucial to perform motion compensation of the subsequent Predicted frames, thus a lower average channel coding rate (i.e. a higher protection) should be associated to Intra frames, while Predicted frames can be coded with a higher average rate (i.e. a lower protection). FIG. 2 shows a schematic representation of the described protection scheme.

UEP may be performed through Rate Compatible Punctured Convolutional (RCPC) codes, with rates chosen according to a perceived importance of bits. In this case the codes considered are obtained by puncturing the same “mother” code. Only one coder and one decoder are then needed for performing coding and decoding of the whole bit-stream. Rate Compatible Punctured Convolutional Codes as such are known from the article of J. Hagenauer, “Rate-Compatible Punctured Convolutional Codes (RCPC Codes) and their Applications”, IEEE Trans. Commun., vol.36, no.4, pp. 389-400, April 1988.

Different average code rates are taken into consideration for the protection of different frames (I frames are coded with a higher protection/lower rate, a lower protection/higher average rate is taken into consideration for P frames), and for each frame the data partitioning tool added to the MPEG-4 standard is exploited, in order to provide a stronger protection for the most significant partitions. A frame may be retransmitted if not correctly received.

An MPEG-4 coded bit-stream is structured in Video Objects (VO), Video Object Layers (VOL), Groups of Video Object Planes (GOV), Video Object Planes (VOP), and Packets. In order to allow synchronization, a start of each part of the bit-stream is indicated by a relevant start code. Start codes are unique words, recognizable from any legal sequence of variable length coded words. H1 indicates the start code for the VO, H2 for the VOL, H3 for the GOV, H4 for the VOP and H5 the packet start code (resync).

A main problem is that MPEG-4 start codes are not robust to errors: a single error in a start code may cause missed detection, resulting in a loss of synchronization. In order to cope with these problems, the invention proposes some advantageous solutions. If errors occur, start codes emulation is possible, as well as a missed detection.

In order to solve this problem, a start code substitution according to an aspect of the invention is proposed.

Start Code Substitution

In the proposed scheme, start codes are substituted after MPEG-4 coding (see FIGS. 3 and 4) with pseudo-noise words, which are sequences with high correlation properties (e.g. Gold sequences). These new start codes are denoted by Wireless Start Codes. In particular, a substitution is performed for VO, VOL, VOP, GOV start codes and for the Resync marker. FIG. 3 shows a coded data stream S, comprising the markers H1 . . . H5. These markers are substituted with markers WH1 . . . WH5 which have a higher robustness to channel errors, to obtain a data stream WS which is suitable for wireless transmission. The data stream WS is received in a receiver as a data stream RS which is similar to WS but may have channel errors. The markers WH1 . . . WH5 are received as WH1_{R}. . . WH5_{R}. The markers (words) WH1_{R}. . . WH5_{R} are similar to WH1 . . . WH5 but may have channel errors. Because these markers have high correlation properties, they are recognized as being WH1 . . . WH5 which are thereafter substituted by markers similar to H1 . . . H5 respectively. The data stream (S) in FIGS. 3 and 4 does not include the GOV start code (H3), considering the MPEG-4 bit-stream. In the MPEG-4 bit-stream there is no GOV start code (H3) after the VOL start code (H2), because the VOL start code (H2) also indicates the beginning of a GOV.

At the receiver side, the position of these wireless start codes WH1 . . . WH5 are estimated through correlation before the channel decoding process; a trade-off should be achieved between the probability of missing a start code and the probability of start codes emulation, thus the choice of the wireless start codes length and of a proper threshold for the correlation is performed accordingly. As the detection is performed, wireless start codes WH1 . . . WH5 are substituted with the corresponding start codes H1 . . . H5 from an original set of start codes. The described substitution is herewith transparent to the MPEG-4 decoder (see FIGS. 6 and 8).

A second main problem is that MPEG-4 packets are not exactly of the same length and partitions have different lengths in different packets, due to the variable length coding used and to the requirement of having an integer number of macro-blocks in each packet. This implies that a fixed UEP scheme cannot be used and, in order to perform decoding with the correct code rate, the bit-stream structure should be known at the receiver, at channel decoding level. Packets, like partitions, are not of the same length; thus the UEP scheme should be dynamically changed for each packet and the knowledge of the partition length is required. As far as this problem is concerned, two alternative solutions for performing UEP are proposed: Proportional UEP and Length field insertion joint with UEP.

FIG. 9 shows a scheme of Proportional Unequal Error Protection. As the length of each field is not known at the receiver, a proportional scheme is used, given the (variable) length of the packet. Packet length is preferably determined through the reception of two proper start codes (at least one of which is a packet start). A delay of one packet is introduced by such a scheme in order to fill the packet buffer. A percentage length is chosen for each partition taking into account the characteristics of the bit-stream. Given three partitions of percentage length P₁, P₂, P₃, protected with rates R₁, R₂, R₃, the average rate for I packets is given by:

$${R}_{avg} = \frac{{R}_{1} {R}_{2} {R}_{3}}{{P}_{1} {R}_{2} {R}_{3} + {P}_{2} {R}_{1} {R}_{3} + {P}_{3} {R}_{1} {R}_{2}}$$

R_{avg}=R₁R₂R₃/P₁R₂R₃+P₂R₁R₃+P₃R₁R₂

Similarly, for P packets:

$${R}_{avg}^{′} = \frac{{R}_{1}^{′} {R}_{2}^{′} {R}_{3}^{′}}{{P}_{1} {R}_{2}^{′} {R}_{3}^{′} + {P}_{2} {R}_{1}^{′} {R}_{3}^{′} + {P}_{3} {R}_{1}^{′} {R}_{2}^{′}}$$

R_{avg}′=R₁′R₂′R₃′/P₁R₂′R₃′+P₂R′₁R₃′+P₃R₁′R_{2′}

Consequently, the length of the coded packet is:

$${L}_{coded\_packet \_I} = \frac{{L}_{packet}}{{R}_{avg}} + \frac{M}{{R}_{3}} for I frames and$$

$${L}_{coded\_packet \_P} = \frac{{L}_{packet}}{{{R}_{avg}}^{′}} + \frac{M}{{{R}_{3}}^{′}} for P frames$$

where M is the memory of the code, in the case convolutional codes are considered. As for the memory M of the code: convolutional codes differ from block codes in that the encoder contains memory and the encoder outputs at any given time unit not only depend on the inputs at that time unit, but also on M previous input blocks, where M is the memory of the code. A memory M convolutional encoder consists of an M-stage shift register with the output of selected stages being added modulo-2 to form the encoded symbols. Since a convolutional coder is a sequential circuit, its operation can be described by a state diagram. The state of the encoder is defined as its shift register contents; thus an encoder may assume 2^{M} states. In order to protect the last bits of the bit-stream with the same strength of the others, M tail bits should be added to the bit-stream in order to force the encoder to converge back to a known state (typically the “0” state). In fact, if convolutional codes are considered, the packet is terminated by shifting M “0” bits into the shift register in order to allow a proper termination of the trellis. Tail bits are coded with the higher rate. In order to compute the total average rate, the average between I frames and P frames should be computed and the overhead introduced by the start codes substitutions should also be considered.

This aspect of the invention takes respective predetermined percentages of a variable packet length as respective packet partitions. The percentages are preferably determined such that a first partition of the packet comprises at least a first original packet partition (e.g. a header) and a sum of the first and second partitions comprise at least the first original packet partition and a second original packet partition, and so on, taking into account the characteristics of the data stream.

Length Field Insertion

A second solution to the second main problem, is the insertion of a length field in the “W-coded” MPEG-4 bit-stream WS, which is the MPEG-4 bit-stream coded with the proposed scheme. FIG. 4 shows the proposed insertion. Information about the length of the partitions that are or have been protected are enclosed in the data stream, e.g. in a field lf added in each packet after the resync marker. A specific, strong error protection is chosen for the length field, as the information it contains is crucial for the subsequent decoding. At the receiver side, after the detection of a resync marker, the length information is read and decoded (FIG. 8). UEP may then be performed with the knowledge of the length of each partition. In this case, if l₁, l₂, l₃ are the lengths of the three partitions before channel encoding, the length of the coded packet including the length field will be:

$${L}_{coded\_packet} = \frac{{l}_{length\_field}}{{R}_{length\_field}} + \frac{{l}_{1}}{{R}_{1}} + \frac{{l}_{2}}{{R}_{2}} + \frac{{l}_{3} + M}{{R}_{3}}$$

Preferably, the length field lf comprises the lengths of the packet partitions after channel encoding, i.e.

$$\frac{{l}_{1}}{{R}_{1}} , \frac{{l}_{2}}{{R}_{2}} , \frac{{l}_{3} + M}{{R}_{3}} ,$$

l₁/R₁, l₂/R₂, l₃+M/R₃, because these are the lengths of the packet partitions furnished to the channel decoder.

After the length information has been read, the length field is deleted from the bit-stream, i.e. it is not inserted in the bit-stream fed into the MPEG-4 decoder (FIG. 8). As seen for the substitution of the original start codes with the “wireless” ones, also this modification is therefore transparent to the MPEG-4 decoder.

Although the length field insertion as described above is advantageously applied in combination with start code substitution, the length field insertion may be construed as an invention by itself.

At channel coding level, two advantageous embodiments according to the invention are proposed:

1. Start Codes Substitution combined with Proportional Unequal Error Protection (P-UEP); and

2. Start Codes Substitution combined with Length Field Insertion and UEP.

Description of the Advantageous Embodiments

In the following a description of the advantageous embodiments is given for the simplified case of VOP's coincident with frames.

In FIGS. 5-8 dashed lines indicate control lines.

FIG. 5 shows a first transmitter 1 according to the invention, the first transmitter comprising a start code detector 12 for detection of the start codes H1 . . . H5. A detected start code is substituted by a corresponding pseudo-noise word WH1 . . . WH5 by a pseudo-noise word generator 13. The pseudo-noise word WH1 . . . WH5 is furnished to a multiplexer 14 that includes the pseudo-noise word in the data stream WS to be transmitted.

The data stream S is received in a packet buffer 10. Packets of the data stream S, present in between the markers H1 . . . H5, are channel encoded in a channel coder 11 to obtain channel coded packets. These channel coded packets are furnished to the multiplexer and are included in the data stream WS to be transmitted. The transmitted data stream is furnished to an antenna, e.g. for wireless transmission, or to a storage medium 15.

Channel coding in FIG. 5 is advantageously performed using P-UEP as described above, but other channel coding mechanisms may alternatively be used.

FIG. 7 shows a second transmitter 2 according to an embodiment of the invention, similar to the transmitter of FIG. 5, but arranged to perform length field insertion. The second transmitter comprises hereto a length field insertion unit 20 that furnishes a length field lf to the multiplexer 14 in order to include a length field lf in the transmitted data stream WS′ in a way as described above, especially in relation to FIG. 4. In this embodiment, the length field insertion unit 20 is controlled by the start code detection unit 12.

FIGS. 6 and 8 show receivers 3 and 4 for receiving data streams WS and WS′ transmitted by an embodiment similar to FIGS. 5 and 7 respectively. In a start codes detector 32 (e.g. a pseudo-noise word detector), correlation evaluations are performed between each allowed pseudo-noise word (i.e. from the predetermined set of pseudo-noise words, corresponding to the markers) and the relevant bit-stream portion in order to detect pseudo-noise words representing start codes. Correlations are compared with corresponding thresholds th. When a pseudo-noise word is detected, the bit indicator in the bit-stream shifts the proper number of bits and the corresponding MPEG-4 start code H1 . . . H5 is provided by start code generator 33, which start code is inserted in a multiplexer 34 whose task is to arrange a bit-stream S′ to be fed to the MPEG-4 decoder. If either a GOV start code or a VOP start code is detected, a VOP indicator changes its status.

If a resync marker is detected, a packet buffer 30 is initialized and subsequent bits fill the buffer until the next start code is detected. No correlation evaluation is performed until the buffer contains N bits, where N is the minimum length of a packet. When the next start code is detected, the buffer 30 includes one packet; channel decoding is performed on the bits in the buffer in a channel decoder 31, according to the VOP indicator information and to either the percentages (FIG. 6) or the length information (FIG. 8) included in the length field lf. The rates used in the scheme are preferably fixed and the same as used in the channel encoder 11. In the case of variable rates, the rates have to be received from the channel encoder 11 in the transmitter. The channel-decoded packets are inserted in the multiplexer 34 arranging the bit-stream to be fed to an MPEG-4 decoder. Note that if RCPC codes are used, de-puncturing is performed before decoding. In this case, the packet is then decoded at the mother code rate.

Although not shown in FIGS. 5-8, the data stream may be modulated before transmission by a modulator in the transmitter and consequently be demodulated in the receiver by a demodulator before decoding is performed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, coding of a data stream is provided, the data stream comprising at least one marker out of a predetermined set of at least two mutually different markers, the marker indicating a start of a given part of the data stream, wherein the at least one marker is represented with a higher-robustness word having a higher robustness to channel errors than the at least one marker, e.g. a pseudo-noise word. Advantageously, the higher-robustness word representing the at least one marker is obtained from a predetermined set of higher-robustness words, each higher-robustness word in the predetermined set of higher-robustness words corresponding to a given marker in the predetermined set of markers.

Further, decoding is provided, wherein a position of a given higher-robustness word is determined by correlating the received data stream with higher-robustness words obtained from a predetermined set of higher-robustness words and the given higher-robustness word is decoded to obtain a marker represented by the higher-robustness word at the determined position.

1. A method of coding a data stream, the data stream comprising at least one marker out of a predetermined set of at least two mutually different markers, the marker indicating a start of a given part of the data stream, the method comprising:
representing the at least one marker with a higher-robustness word having a higher robustness to channel errors than the at least one marker; and
outputting the data stream with the at least one marker represented with the higher-robustness word.

2. A method as claimed in claim 1, wherein the higher-robustness word is a pseudo-noise word.

3. A method as claimed in claim 1, wherein the higher-robustness word representing the at least one marker is obtained from a predetermined set of mutually different higher-robustness words, each higher-robustness word in the predetermined set of higher-robustness words corresponding to a given marker in the predetermined set of markers.

4. A method as claimed in claim 1, the method comprising:
further channel coding the given part of the data stream according to a further channel coding mechanism.

5. A method as claimed in claim 4, wherein the further channel coding comprises:
coding respective partitions of the given part of the data stream with different error protection rates, wherein respective lengths of the respective partitions are determined by respective predetermined percentages of a length of the given part of the data stream.

6. A method as claimed in claim 4, wherein the further channel coding comprises:
coding respective partitions of the given part of the data stream with different error protection rates, wherein information concerning respective lengths of the respective is included in the data stream.

7. A method as claimed in claim 1, wherein the data stream is an MPEG-4 data stream, and the predetermined set of markers comprises a video object start code, a video object layer start code, a video object plane start code, a group of video object planes, and a resynchronization marker.

8. A method of decoding a data stream, the received data stream comprising higher-robustness words respectively representing markers that indicate starts of respective parts of the data stream, the higher-robustness words having a higher robustness to channel errors than the markers that are respectively represented with the higher-robustness words, the method comprising:
determining a position of a higher-robustness word; and
replacing the higher-robustness word by a marker represented by the higher-robustness word at the determined position.

9. An encoder for coding a data stream, the data stream comprising at least one marker out of a predetermined set of at least two mutually different markers, the marker indicating a start of a given part of the data stream, the encoder comprising:
means for representing the at least one marker with a higher-robustness word having a higher robustness to channel errors than the at least one marker; and
means for outputting the data stream with the at least one marker represented with the higher-robustness word.

10. A decoder for decoding a data stream, the received data stream comprising higher-robustness words respectively representing markers that indicate starts of respective parts of the data stream, the higher-robustness words having a higher robustness to channel errors than the markers that are respectively represented with the higher-robustness words, the decoder comprising:
means for determining a position of a higher-robustness word; and
means for replacing the higher-robustness word by a marker represented by the higher-robustness word at the determined position.

11. A transmitter for transmitting a data stream, the transmitter comprising:
an encoder as claimed in claim 9; and
antenna means for transmitting the data stream.

12. A receiver for receiving a data stream, the receiver comprising:
antenna means for receiving the data stream; and
a decoder as claimed in claim 10;

13. A data stream comprising higher-robustness words respectively representing markers that indicate starts of respective parts of the data stream, the higher-robustness words having a higher robustness to channel errors than the markers that are respectively represented with the higher-robustness words.

14. A storage medium on which a data stream as claimed in claim 13 has been stored.
